(19) United States
(12) Patent Application Publication
(10) Pub. No.: US 2008/0189268 A1
(43) Pub. Date: Aug. 7, 2008

(54) MECHANISM FOR AUTOMATIC MATCHING OF HOST TO GUEST CONTENT VIA CATEGORIZATION

(76) Inventor: Lawrence Au, Vienna, VA (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/866,901

(22) Filed: Oct. 3, 2007

Related U.S. Application Data
(60) Provisional application No. 60/848,653, filed on Oct. 3, 2006.

(51) Int. Cl. G06F 17/30

(52) U.S. Cl. 707/5; 707/E17.017

(57) ABSTRACT

An automatic matching mechanism includes a method for mapping a unit of content to other units of content. The method includes a host display sending a request for guest content. The method may also include: querying a category content index for the guest content and providing indexed and categorized content that corresponds to the request, providing the indexed and categorized content for display in response to determining the indexed and categorized content is not either new content or updated content, and displaying the categorized content on a host display. The automatic matching mechanism may include a method for generating matching guest content for a host display. The method includes: sending a guest request to preview matched content and querying a category content index for the guest matched content, gathering category related semantic content information from a semantic content index, and reporting categorized matching content that matches the guest request.

This application claims the benefit of U.S. Provisional Application Ser. No. 60/848,653 filed on Oct. 3, 2006, which is herein incorporated by reference in its entirety.

This patent application is related to U.S. patent application Ser. No. 10/329,402, which is a continuation-in-part of U.S. patent application Ser. No. 09/085,830, now issued as U.S. Pat. No. 6,778,970, and related to U.S. Pat. No. 7,107,264 B2 to Qi Lu, and related to provisional patent application No. 60/808,955 entitled CHAT CONVERSATION METHODS TRAVERSING A PROVISIONAL SCAFFOLD OF MEANINGS, filed May 30, 2006, and related to provisional patent application No. 60/808,956 entitled AUTOMATIC DATA CATEGORIZATION WITH OPTIMALLY SPACED SEMANTIC SEEDS, filed May 30, 2006. Each of these related references is herein incorporated by reference in its entirety.

### BACKGROUND OF THE INVENTION

1. Field of the Invention

This invention relates to internet searches and, more particularly, to content matching of search results.

2. Description of the Related Art

To quickly match similar content on the Internet, for advertising and cross-referencing the World Wide Web, advertisers and publishers have attempted to build cross-references by hand or by automated keyword cross-references. Inability of hand-built cross-references to keep up with the rapid expansion of the web has put automated keyword cross-references in the spotlight. The need to promote visitor traffic from search engines to web sites, along with the existence of popular cross-referencing keywords, have encouraged web site owners to include those keywords whether or not the meaning of those words actually appears in their sites. These spurious words cause keyword cross-references to produce mainly false positive results for any sites containing popular keywords.

In one approach to overcome the above shortcomings, builders of automatic cross-references have attempted to infer real meaning of web sites by analyzing web hyper-links. The popularity of hyper-link cross-references has encouraged web site owners to include hyper-links to both their sites and other popular sites, whether or not these extra hyper-links connect to sites of any relationship or value for advertising or cross-referencing purposes. These spurious links cause hyper-link cross-references to produce mainly false positive results for any popular sites that have been hyperlinked in this way.

To overcome these deficiencies, builders of automatic cross-references have employed semantic techniques in an effort to infer real meaning of web sites. These semantic techniques involve parsing site content with respect to semantic terms contained in a taxonomy, and then matching sites having similar semantic terms. A major limitation of these techniques, however, is the coverage of the taxonomy, which, being hand-built, is typically orders of magnitude smaller than the vocabulary of words and/or phrases on the World Wide Web.

Still other limitations of this approach come from the sheer number of semantic terms contained in any one document. Some of these terms are more salient to the essential meaning of the document than others. The position of these terms within a taxonomy, however, cannot determine which terms in actual documents best represent the meaning of the document. Consequently, conventional teachings such as Lu (U.S. Pat. No. 7,107,264 B2), which match web sites and/or documents based upon simple taxonomies, fail to enable consistently accurate matching of web sites and/or documents.

To achieve more consistently accurate matching of web sites and/or documents, one approach attempted by builders of automatic cross-references is to employ statistical techniques to infer the real meaning of web sites. For instance, it has been attempted to trace sequences of clicks from site to site across hyperlinks to determine which sites have tended to be clicked on from other sites. These statistical techniques, however, have two major shortcomings: (1) an inability to analyze the small sample sets of clicks on rarely visited but nevertheless meaningful sites; and (2) an inability to analyze rare meanings of frequently visited sites. These shortcomings have caused a high number of false positives and false negatives when matching sites to sites using this approach.

Therefore, to achieve that goal of preventing high numbers of false positive and/or false negative matches, there may be a need for a way to accurately match documents or other units of content, using techniques that produce more accurate results than conventional techniques.

### SUMMARY

Various embodiments of a mechanism for automatic matching of host to guest content using categorization are disclosed. Broadly speaking, a mechanism for accurate matching of documents and/or other units of content, such as web sites or paragraphs, that use particular categorization techniques is contemplated. More particularly, by using accurate categorization techniques, especially those described below and taught by provisional patent application No. 60/808,956, entitled AUTOMATIC DATA CATEGORIZATION WITH OPTIMALLY SPACED SEMANTIC SEEDS, the salient meaning of a unit of content can be more accurately mapped to other units of content, thereby effectively matching units of content to create a view of other units of content sharing similar meanings with the unit of content being matched. Categorization matching may provide, in addition to the more accurate matching, categorization of the resulting matches. Further, using methods taught by provisional patent application No. 60/808,956, categorizations are made around semantics introduced by actual content, thus enabling categorization to be accurate even when new semantic terms are the most salient terms in a unit of content.

By enabling accurate categorization matching, the automatic matching mechanism may further enable advertisers to bid on inexpensive salient specific categories, rather than on ambiguous overused keywords, the value of which is bid up in price by competing advertisers overloading bids for popular keywords, and which provide poor product differentiation.

The automatic matching mechanism may further enable editing of Internet advertising copy to include more salient specific category phrases, and provide an opportunity for immediate assessment of whether the improved copy produces improved advertising coverage via dissemination to other web sites. By enabling advertisers to improve advertising coverage by coining new specific category phrases, rather than by bidding up keywords in price, the automatic matching mechanism may reduce keyword advertising inflation and broaden the utility of web advertising to a wider group of advertisers. The automatic matching mechanism may effectively enable small companies to advertise niche products and services by bidding on phrases automatically parsed from the companies' advertising copy, without the expense of search engine optimization experts that would otherwise necessarily be hired to tune advertising copy with keywords. In addition, the method and system of the present invention may effectively eliminate the expense of search engine optimization experts that would necessarily be hired to purchase sets of keywords.

In one embodiment, an automatic matching mechanism includes a method for mapping a unit of content to other units of content. The method includes a host display sending a request for guest content. The method may also include a host user server, for example, querying a category content index for the guest content and providing indexed and categorized content that corresponds to the request. The method also includes providing the indexed and categorized content for display in response to determining the indexed and categorized content is not either new content or updated content. Further the method includes displaying the categorized content on a host display.

In one specific implementation, the method includes adding the indexed and categorized content to a semantic content index in response to determining the indexed and categorized content is either one of new content and updated content. In addition, the method may include gathering category related semantic content information from the content semantic content index, and re-categorizing the gathered category related semantic content information.

In another specific implementation, the method may include providing a search term and a query request including the search term, searching a data store using the search term, and selecting a document set that corresponds to the query request. The document set may include documents having semantic phrases that are related to the search term.

In another embodiment, the automatic matching mechanism includes a method for generating matching guest content for use on a host display. The method includes sending a guest request to preview matched content and querying a category content index for the guest matched content. The method may also include providing the requested indexed and categorized guest content that corresponds to the request and adding the indexed and categorized guest content to a semantic content index. The method may further include gathering category related semantic content information from a semantic content index and re-categorizing the gathered category related semantic content information. In addition, the method may include adding the re-categorized category related semantic content information to the category content index and reporting categorized matching content that matches the guest request.

### BRIEF DESCRIPTION OF THE DRAWINGS

FIG. 1 is a diagram depicting one embodiment of a mechanism for automatically matching units of content to other units of content.

FIG. 2 is a diagram depicting an exemplary embodiment of a host display unit of content as shown in FIG. 1.

FIG. 3 is a diagram depicting an exemplary embodiment of a guest display as shown in FIG. 1.

FIG. 4 is a flow diagram depicting one embodiment of a method for semantically indexing new or updated host content, and merging the semantically indexed new or updated host content with semantically related content, which is categorically displayed.

FIG. 5 is a flow diagram depicting one embodiment of a method for disseminating, by the owner or creator of guest content, portions of guest content to host units of content, as well as competitively bidding in order to pay for that dissemination.

FIG. 6 is a block diagram of one embodiment of a computer system upon which the mechanism for automatic matching may be implemented.

FIG. 7 is a block diagram of one embodiment of a communication system within which the mechanism for automatic matching may be implemented.

FIG. 8 is a flow diagram depicting one embodiment of a method for automatically categorizing data.

FIG. 9 is a flow diagram depicting one embodiment of a method for parsing documents into semantic terms and semantic groups.

FIG. 10 is a flow diagram depicting one embodiment of a method for ranking semantic terms to find an optimal set of semantic seeds.

FIG. 11 is a flow diagram depicting one embodiment of a method for accumulating semantic terms around a core optimal set of semantic seeds.

FIG. 12 is a flow diagram depicting one embodiment of a method for parsing sentences into subject, verb, and object phrases.

FIG. 13 is a flow diagram depicting one embodiment of a method for resolving anaphora imbedded in subject, verb, and object phrases.

FIG. 14 is a flow diagram depicting one embodiment of a method for analyzing semantic terms imbedded in a phrase tokens list, outputting an index of semantic terms and an index of locations where semantic terms are co-located.

FIG. 15 is a diagram depicting an embodiment of a web portal web search user interface using an automatic categorization of web pages to summarize search results into a four categories.

FIG. 16 is a diagram depicting search results of the embodiment of the web portal web search user interface of FIG. 15.

FIG. 17 is a diagram additional search results of the embodiment of the web portal web search user interface of FIG. 15.

FIG. 18 is a flow diagram depicting one embodiment of a method for using the embodiment of the automatic categorizer of FIG. 8 to automatically augment semantic network dictionary vocabulary

FIG. 19 is a flow diagram depicting one embodiment of a method for using the automatic augmenter shown in FIG. 11 to add new vocabulary just before new vocabulary is needed by a search engine portal.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

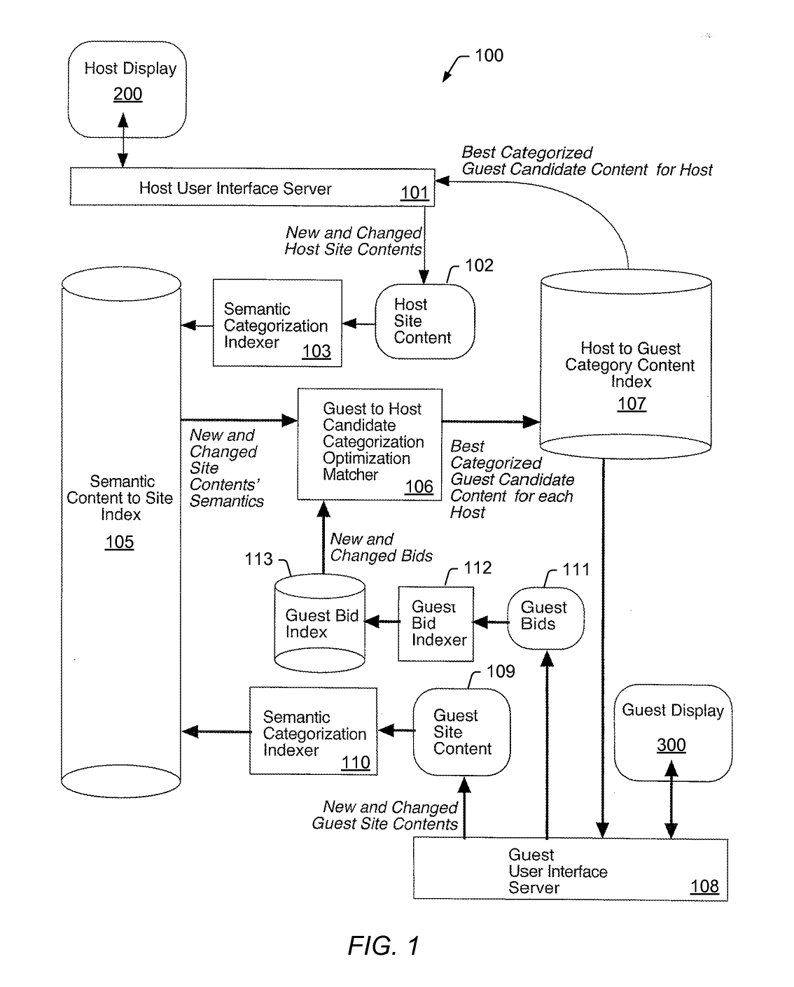

Turning now to FIG. 1, a diagram depicting an embodiment of a mechanism for automatically matching units of content to other units of content is shown. Due to the vast amount of content on the World Wide Web and/or other large information storage systems, one approach for efficient access to this content is to use indices at the core of the information processing architecture. However, it is noted that other approaches, such as content-addressable memory, for example, may be used to access to such content.

In the illustrated embodiment, the automatic matching mechanism 100 uses at least two large-scale indices. One of the two large-scale indices may be, for example, a Semantic Content-to-Site (SCS) index 105, describing semantic terms and each term's actual usage, such as actual sentences in the content of units of content (e.g., documents or web sites). The SCS index 105 may be used by a central repository for semantic meanings to categorize when matching units of content is performed. The second of the two large-scale indices may be, for example, a host-to-guest-category-content (HTGC) index 107, comprising a central index configured to quickly retrieve the results of prior categorization which matched units of content. In various embodiments, these indices may provide superior response time and scalability. These indices may be built, for example, upon a radix tree or TRIE tree structure, which may provide better overall response times than hash tables. Particularly for index sets of greater than 100,000 elements, for example. In one embodiment, to achieve scalability, the indices (e.g., 105 and 107) may be distributed across multiple servers, where each server may support a truncated sub-tree portion of the overall index, and each sub-tree may point to other sub-trees on other distributed servers. Index traversal may be computed via packets passed from server to leafward server until a terminating tree leaf is reached.

In addition, the two central indices (e.g., 105 and 107) used in one embodiment also eliminate extra undesirable traversals of indices. For example, as described in U.S. Pat. No. 7,107,264 B2 (“Lu”), Lu teaches the use of a “distiller” to distill host contents into an indexed host content database and the subsequent composition of a query for querying an indexed guest content database. Lu requires traversal of both a host content index and a guest content index, in addition to composition of an intermediary query to connect the two traversals. Since complex queries involving nested compound Boolean conditions are often improperly optimized by database systems, the teaching of Lu not only wastes processor power by traversing two indices, but also wastes processor power with unnecessary query composition, posting and optimization. This is in contrast to the single traversal of the SCS index 105 in FIG. 1. Furthermore, Lu's teaching of the use of queries may also cause false positive and false negative results in matching because it may be impractical to distill complex documents into a simple keyword queries without error. It may also be impractical to distill complex documents into complex nested Boolean queries without error, because nested Boolean queries are a poor semantic representation of meaning. Furthermore, a database cannot accurately capture semantic meaning without the intervention of a database architect to hand-design and normalize database tables. Queries based upon a database design therefore cannot accurately retrieve newly formed natural language semantic meanings which are a great portion of the content of the World Wide Web and other large data repositories.

Accordingly, in one embodiment, the automatic matching mechanism 100 may entirely avoid queries, databases and the associated performance and semantic limitations, by directly using a set of semantic terms in the SCS index 105 as an input to a Guest to Host Candidate Categorization Optimization Matcher (GHCCOM) 106. A set of semantic terms, along with each term's actual usage within content, may provide an excellent basis for categorization by either a conventional statistical categorizer or by a more accurate categorizer such as the categorizer described in greater detail below and described provisional patent application No. 60/808.956. Since Lu does teach the use of a simple taxonomy instead of an optimizing categorizer capable of automatically dealing with new category semantic terms, the coverage of Lu's “evaluator,” which matches content is generally insufficient to match general World Wide Web content. Lu performs reasonable matching in very limited circumstances, (e.g., when Lu's taxonomy covers all necessary semantic terms in a restricted topic small enough for lexicographers to map by hand). It is noted that the remaining blocks of FIG. 1 are described further below.

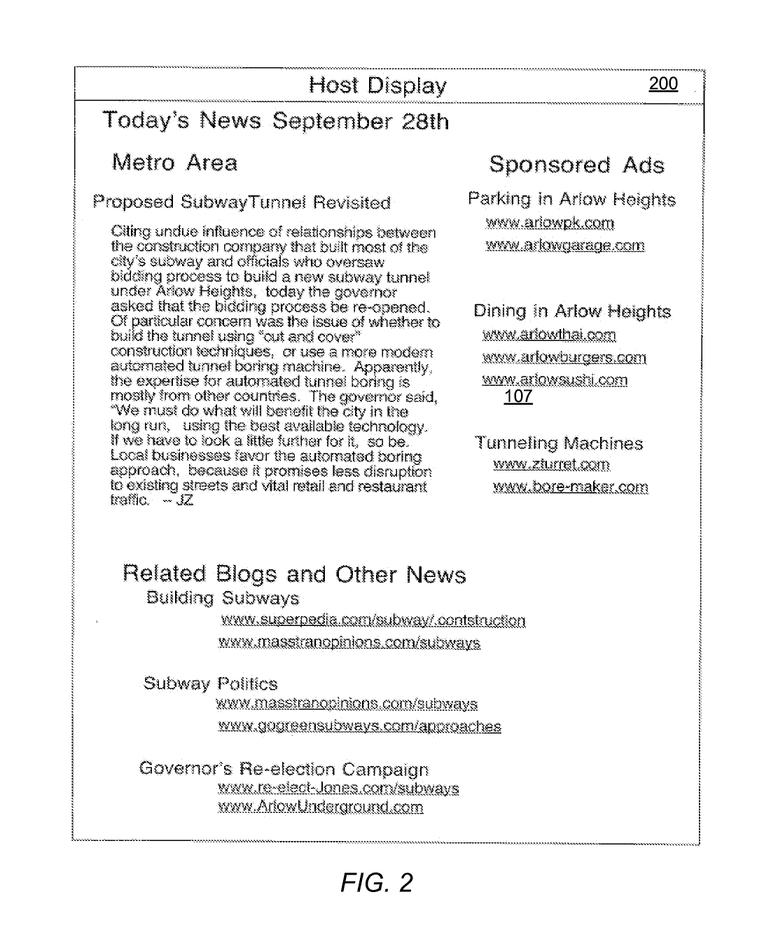

Referring now to FIG. 2, one embodiment of a host display unit of content, such as a web site or document page, which includes content from other categorically matching units of content is shown. At the top left hand side of the host display 200, is a headline “Proposed Subway Tunnel Revisited” with a brief story underneath. To the right are related Sponsored Ads categorized by the type of relation. In the lower half of Host Display 200, related units of content categorized by type of relation are shown. By providing categories with headers as links to related content, host display 200 succinctly explains why guest content, such as (<www.arlowburgers>), is related to the host content of FIG. 2. Thus, categorization enables readers of host content to skip past related guest content that is currently of little interest. In addition, categorization also compresses the space needed to explain why a user should click on guest content, thus conserving valuable display space on the host display. Accordingly to realize the above benefits of categorization, it may be useful to use a categorizer such as the categorizer described in greater detail below and in provisional patent application No. 60/808,956 for performing the categorizer function of GHCCOM 106 in FIG. 1.

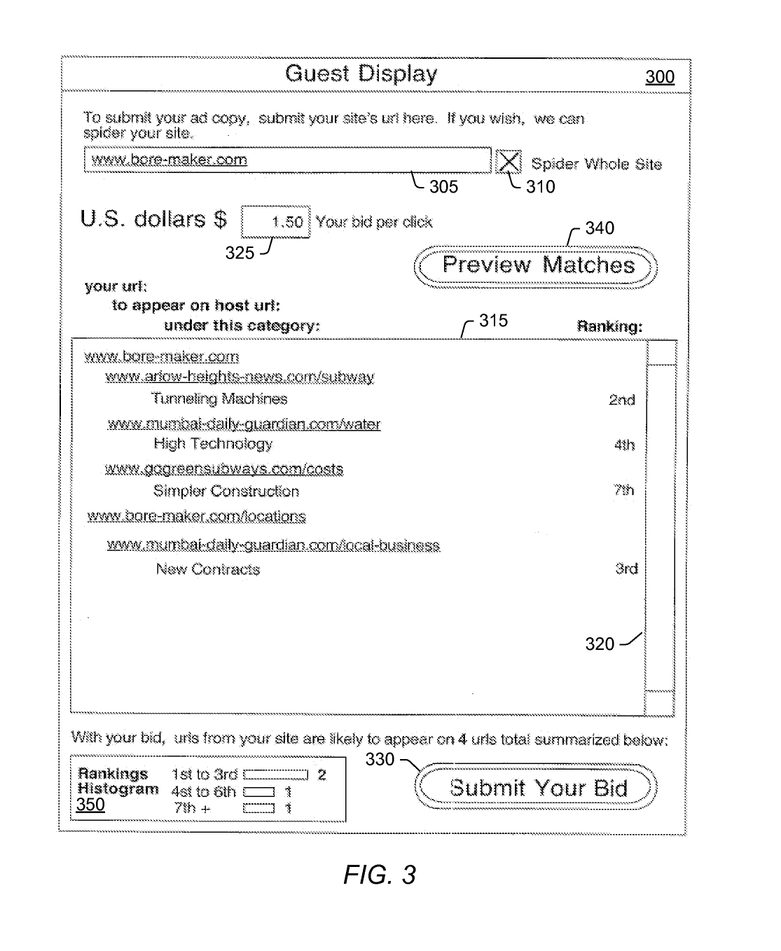

Turning to FIG. 3 a diagram depicting an exemplary embodiment of a guest display is shown. The guest display 300 may enable owners or creators of other content to automatically categorically display portions of such other content within units of content of a host display. By entering a Uniform Resource Locator (URL) such as <www.bore-maker.com> in the URL entry box 305 at the top of the guest display 300 and pressing the Preview Matches button 340, an owner or creator of guest content may initiate a request for the Guest User. Referring collectively to FIG. 1 through FIG. 3, the guest user interface server 108 of FIG. 1 to may access guest site content 109 at the provided URL. By checking the “Spider Whole Site” checkbox 310, the Guest User Content will also access Guest User Content of linked content URLs from the same site. After the Semantic Categorization Indexer 103 parses and stores the semantics and their related content, such as sentences, for example, in the SCS Index 105, all updated and related entries under the same or synonymous entries are passed to the GHCCOM 106 to produce relationship categories and matching Host units of content, as shown in the scrollable area 315 of guest display 300. The scrollbar 320 is shown as a long slender rectangle on the right. Since the content of the scrollable area 315 has not yet exceeded its display length, the scrollbar 320 is shown blanked-out, symbolizing a state of dormancy. This scrollable area 315 provides a snapshot of the matching relationships automatically produced by, the automatic matching mechanism 100. The scrollable area 315 also provides feedback to provide an opportunity for the owner or creator of guest content to quickly revise the content. For example, the creator may tweak the terminology and catchy phrases, and subsequently press the Preview Matches button 340 again so that better coverage and rankings can be achieved without bidding higher for the category terms. This feature may enable advertisers to compete by better describing their offerings, rather than just competing by paying more money for advertising. As such, the former may reduce the total cost to society of mapping sellers to buyers, wand the latter may serve only to inflate advertising pricing while compromising the economic value of direct niche sellers who cannot afford high advertising pricing.

In one embodiment, for a quick overview of rankings achieved, the guest display 300 provides a histogram 350 of the number of matches at various ranking categories. For computations involving more than a dozen matches, reviewing such a histogram may be easier than scrolling through the list of match details in the scrollable area.

Should an owner or creator of guest content be satisfied with matching results, the owner or creator may enter a bid amount in the bid box 325 and press the Submit Your Bid button 330 at the bottom of the guest display 300. In most cases, after pressing submit button, the owner or creator will be financially liable for the bid price that was entered in the bid box 325. It is contemplated that the liability will be in currency units of dollars per click, triggered when viewers of host content click on the guest content links. However, the liability may also be monetized, among other methods, in units of currency per displays of guest content links, units of currency on a percentage basis of business transacted on the click-through to guest content links. In some embodiments, the units of currency may even be non-commercial methods of valuation via units of non-financial recommendation (e.g., no cash value such as votes) circulated among participants in a system to promote works for a common cause, such as International Semantic Web efforts to employ volunteer labor to help cross-index the World Wide Web.

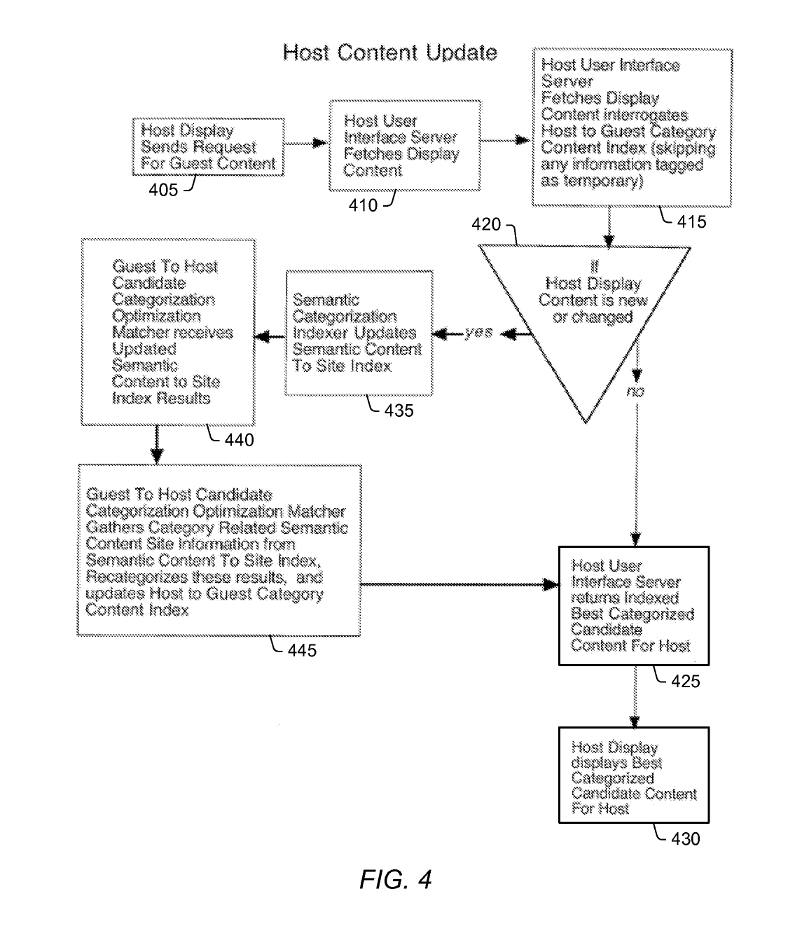

In FIG. 4 a flow diagram depicting one embodiment of a method for semantically indexing new or updated host content, and merging the semantically indexed new or updated host content with semantically related content, which is categorically displayed is shown. Referring collectively to FIG. 1 through FIG. 4, in block 405 of FIG. 4, the host display 200 sends a request for guest content to the host user interface 101. The host user interface server 101 fetches the display content (block 410). The host user interface server 101 fetches the display content by interrogating the host to guest category content index 107 (block 415). However any information that may be tagged as temporary may be skipped. The host user interface server 101 receives, from the host to guest category content index 107, indexed best-categorized candidate content. The host user interface server 101 determines whether the fetched display content is new or updated. If the host display content is not new or changed (block 420), the host user interface server 101 returns indexed best categorized candidate content for the host (block 425). The host display 20 then displays the best-categorized candidate content for the host (block 430).

Unlike the teaching of Lu, as described in U.S. Pat. No. 7,107,264 B2, in the embodiments of FIG. 1 through FIG. 4 previously indexed related content is not recomputed unless either host or related guest content has meaningfully changed. This greatly reduces processor demands from the Host User Interface Server 101 of FIG. 1. Also, in contrast to the teaching of Lu, described above, the embodiments of FIG. 1 through FIG. 4 do not create a query, nor do they involve a database for indexing into content, thus avoiding pitfalls of translating natural language semantics into database semantics over unbounded semantic domains such as the World Wide Web or other large-scale information content repositories.

However, if the host display content is new or changed (block 420), the semantic categorization indexer 103 updates the semantic content to site index 105 by transferring the host display content (block 435). The GHCCOM 106 receives the updated semantic content to site index results (block 440). The GHCCOM 106 then gathers category related semantic content site information from the semantic content to site index and re-categorizes the results. The GHCCOM 106 updates the host to guest category content index 107 (block 445).

In addition, in contrast to the teachings of Lu, the embodiments of FIG. 1 through FIG. 4 avoid a taxonomy that is limited to the host content domain. The lure of taxonomies that are limited to the host content domain is that they provide a quick fix to limitations in keyword matching by storing keyword synonyms in taxonomy. However, this approach results in many false positives when keywords are ambiguous. Popular keywords, such as loan and mortgage, are mostly ambiguous relative to any document, unless their true semantic meaning is disambiguated using categorization techniques such as described further below and in provisional patent application No. 60/808,956. Therefore, Lu's method of employing a taxonomy that is limited to host content domain may be premature and error-prone when compared with the embodiments of FIG. 1 through FIG. 4, because the full domain of host and guest content must be considered before accurate disambiguation and subsequent content matching can be performed. For example, the meaning of “mortgage” as a financial instrument is different from “mortgage” as a figure of speech as in “to mortgage one's future.” Both meanings could be implied by host content, in which case both meanings should be implied by the matching guest content. Guest content may contain synonyms to “mortgage one's future” such as “shortsighted,” which are computable by analyzing guest content, but not computable by analyzing host content. Thus, semantic disambiguation optimization must be delayed until the full semantic picture of guest content and host content is collected and optimized to compute best descriptive category descriptors as a basis for semantic matching. By employing the taxonomy specialized and describing only host content, as disclosed in Lu, semantic content matching of multiple meanings cannot be properly addressed.

In contrast, using categorization techniques such as described in provisional patent application No. 60/808,956, the GHCCOM 106 of FIG. 1 may provide the capability for disambiguating meanings using example actual guest content that is semantically unified with host content and general dictionary content, which have much greater semantic coverage and integrity than host content taxonomies alone. This may result in a far more accurate basis for semantic content matching, especially when multiple meanings need to be disambiguated.

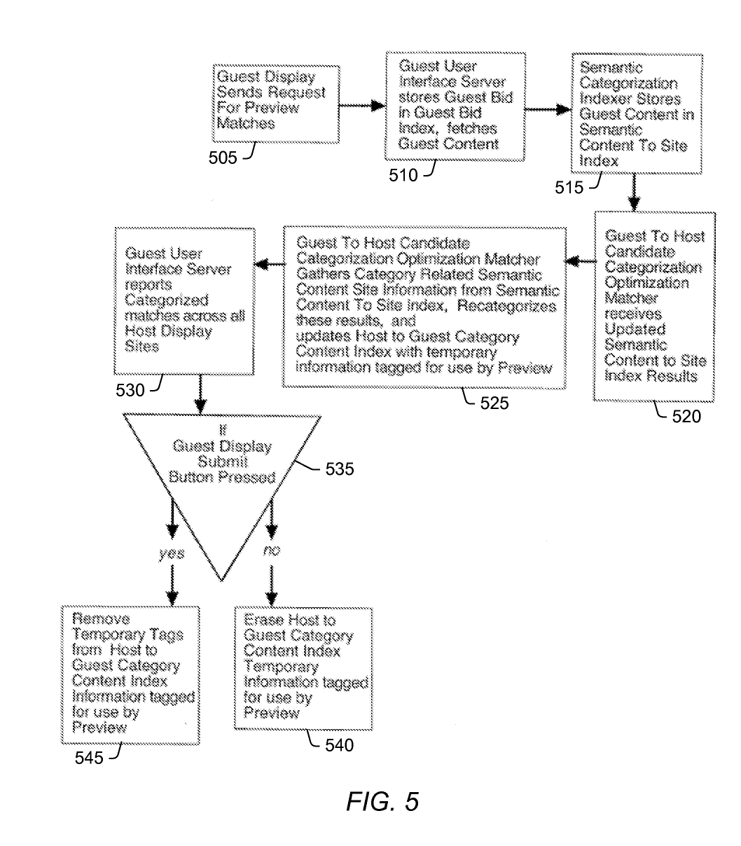

In FIG. 5 a flow diagram depicting one embodiment of a method for disseminating, by the owner or creator of guest content, portions of guest content to host units of content, as well as competitively bidding in order to pay for that dissemination is shown. Referring collectively to FIG. 1 through FIG. 5, by using Preview tags to differentiate proposed bid entries in the Host to Guest Category Content Index from paid bid entries, a single unified index can be used for the processing in both FIG. 4 and FIG. 5. A single unified index reduces the amount of space taken by the index.

Beginning in block 505 of FIG. 5, the guest display 300 sends a request for Preview matches. For example, as described above, a user may enter a URL on the guest display 300 and press the preview matches button 340. The guest user interface server 108 stores the guest bid information in the guest bid index 113 (block 510). In one embodiment, the guest user interface server 108 may upload the guest bid information 111 to be indexed by the guest bid indexer 112, and then stored within guest bid index 113. The guest user interface server 108 stores guest content in the semantic content to site index 105 (block 515). In one embodiment, the guest user interface server 108 may upload the guest site content 109 to be indexed by semantic categorization indexer 110, and then stored within the semantic content to site index 105. The GHCCOM 106 receives the updated semantic content to site index results (block 520). The GHCCOM 106 gathers category related semantic content site information from the semantic content to site index 105 and re-categorizes the received results. The GHCCOM 106 also updates the host to guest category content index with temporary information tagged for use by the preview function (block 525). As described above, in one embodiment, the automatic matching mechanism 100 may use functionality described below and in provisional application No. 60/808,956 within the GHCCOM 106 to produce a set of optimal categories. Each of the categories may contain a set of content sources, such as web sites, and a set of exemplary content, such as sentences, for example. Selecting content only from categories which contain host content sources or exemplary host content, the GHCCOM 106 can quickly produce Categorized Guest Candidate Content for each Host.

The guest user interface server 108 reports categorized matches across all host display sites (block 530). If the user presses the submit bid button 330 (block 535), the temporary tags are removed from the information tagged for use by the preview matches function within the host to guest category content index (block 545).

However, if the user doesn't press the submit bid button 330 (block 535), the information tagged for use by the preview matches function within the host to guest category content index may be erased or otherwise discarded from the host to guest category content index 107 (block 540).

It is noted that in other embodiments, other methods, such as statistical groupings or rule-based traversal of taxonomies, may be used to produce a Categorized Guest Candidate Content for each Host. However, as described below and in provisional application No. 60/808,956, these other methods may not be as optimized. For example, they may suffer from inherent flaws of limited taxonomic coverage, unwanted or missing terms in statistical stopword lists, or ambiguities from parsing at a document level rather than a noun phrase, verb phrase and objective phrase level.

In one embodiment, to sort Categorized Guest Candidate Content for each Host, a method similar to that described in provisional application No. 60/808,956 may be used. For example, as described below, just as Best Candidate Terms are chosen by ranking seed terms by semantic noun phrase, verb phrase and objective phrase level attributes, similar methods of ranking can in part determine which Categorized Guest Candidate Content elements are best for each Host content.

Alternatively, other methods, such as statistical groupings or rule-based traversal of taxonomies, may be used to in part determine which Categorized Guest Candidate Content elements are best for each Host content. However, such methods suffer from inherent flaws of limited taxonomic coverage, unwanted or missing terms in statistical stopword lists, or ambiguities of unresolved anaphora from parsing at a document or sentence level rather than a noun phrase, verb phrase and objective phrase level.

In particular, the method described in Lu employs search parameters based in part upon a host taxonomy suffers ambiguities inherent to the difficulty of defining precise search parameters related to new terminology that categorizers such as the categorizer described below and in application No. 60/808,956 may easily detect. Search parameters cannot in general accurately define the meaning of either host or guest content because such content itself has to be analyzed on a semantic noun phrase, verb phrase and objective phrase level before accurate semantic matching can be computed. For example, just as most people prefer to match books by their meaning by actually reading books and comparing passages from them, rather than comparing indexes in the back of those books, the automatic matching mechanism 100 discloses how to approximate human understanding of semantics by deeply parsing actual content and comparing actual content gathered on the level of sentence grammar as a basis for matching of content.

In contrast, Lu discloses methods using a “distiller” producing search parameters and search queries which only skim the surface of content, thus leaving unresolved serious ambiguities of meaning and subsequently producing frequent false positive and false negative matches inherent to surface-level matching of content. In addition, the limited coverage of a host taxonomy as taught by Lu cannot cover the full semantic meaning of large data repositories such as the World Wide Web.

It is noted that instead of simply submitting a URL for analysis and matching to host content, in an alternative embodiment, a Guest User might chat about the match categories within a Guest User Server's Guest Display, supported by a user interface as described in provisional application No. 60/808,955 entitled CHAT CONVERSATION METHODS TRAVERSING A PROVISIONAL SCAFFOLD OF MEANINGS. Chatting about match categories may enable the Guest User to specify which categories or subcategories were preferred for the matching and bidding, thus providing an alternative for more accurately targeting advertising without editing advertising copy or changing bidding prices.

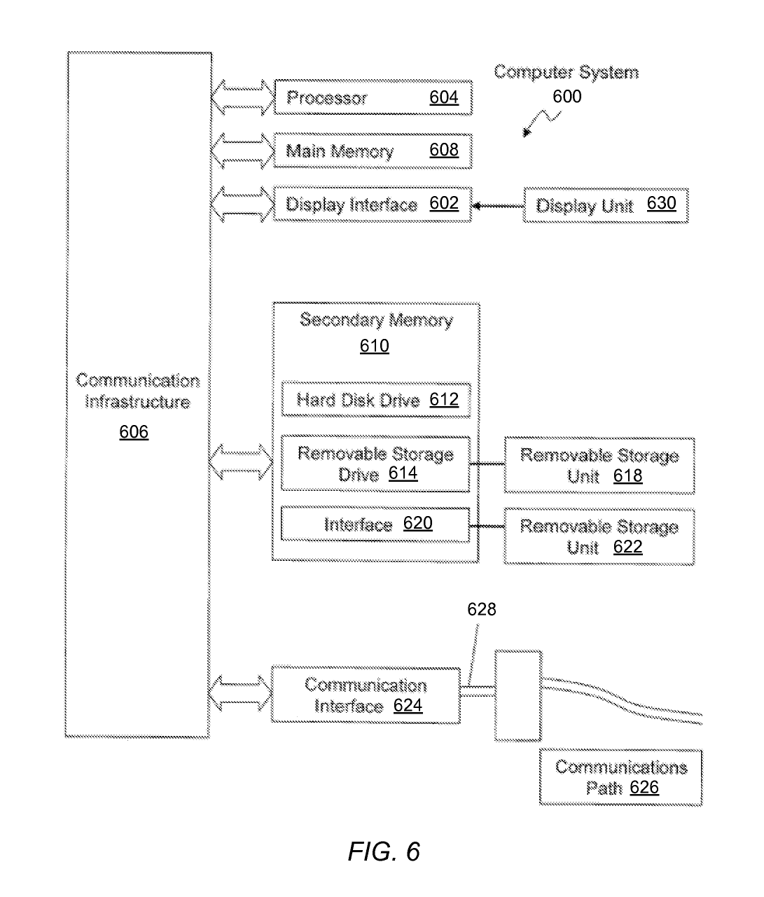

Referring to FIG. 6, an embodiment of such an exemplary computer system 600 is shown. Computer system 600 includes one or more processors, such as processor 604. The processor 604 is coupled to a communication infrastructure 606 (e.g., a communications bus, cross-bar, or other network). Computer system 600 also includes a display interface 602 that may be configured to forward graphics, text, and other data from the communication infrastructure 606 (or from a frame buffer not shown) for display on a display unit 630. Computer system 600 also includes a main memory 608, such as random access memory (RAM), for example, and also a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618. In various embodiments, removable storage unit 618 may represent a floppy disk, magnetic tape, optical disk, etc. and the like. As will be appreciated, the removable storage unit 618 comprises a computer usable storage medium that may store computer executable software and/or data.

In alternative embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an electrically erasable programmable read only memory (EEPROM), or programmable read only memory (PROM)) and associated socket, and other removable storage units 622 and interfaces 620, which allow software and data to be transferred from the removable storage unit 622 to computer system 600.

Computer system 600 may also include a communications interface 624, which may allow software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628, which may be electronic, electromagnetic, optical or other signals capable of being received by communications interface 624. These signals 628 are provided to communications interface 624 via a communications path (e.g., channel) 626. This path 626 carries signals 628 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 680, a hard disk installed in hard disk drive 670, and signals 628. These computer program products provide software to the computer system 600.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 610 to perform the features described in the various embodiments. Accordingly, such computer programs represent controllers of the computer system 600.

In an embodiment where the invention is implemented using software, the software may be stored in a computer program product and loaded into computer system 600 using removable storage drive 614, hard drive 612, or communications interface 620. The control logic (software), when executed by the processor 604, causes the processor 604 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s). In yet another embodiment, the invention is implemented using a combination of both hardware and software.

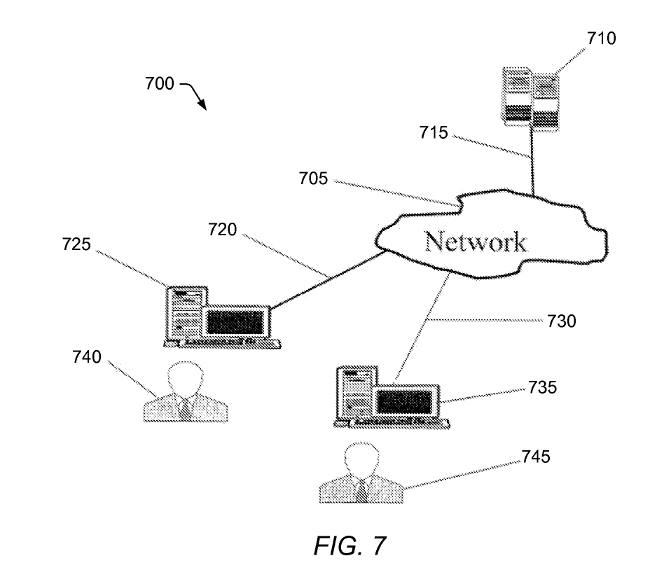

Turning to FIG. 7 a block diagram of one embodiment of a communication system is shown. The communication system 700 includes one or more accessors 740, 745 (also referred to interchangeably herein as one or more “users”) and one or more terminals such as 725 and 735. In one embodiment, data for use in accordance with the present invention is, for example, input and/or accessed by accessors 740 and 745 via terminals 725 and 735. In various embodiments, terminals 725 and 735 may be representative of any type or computer terminal such as personal computers (PCs), minicomputers, mainframe computers, microcomputers, telephonic devices, or wireless devices, such as personal digital assistants (“PDAs”) or a hand-held wireless devices. These terminals may be coupled to a server 710, which may be representative of a PC, minicomputer, mainframe computer, microcomputer, or other device having a processor and a repository for data and/or connection to a processor and/or repository for data. The terminals 725, 735 may communicate with the server 710 via, for example, a network 705, such as the Internet or an intranet, and couplings 715, 720, and 730. The couplings 715, 720, and 730 may include any type of link such as, for example, wired, wireless, or fiber optic links.

Accordingly, embodiments implemented in a networked environment such as the system shown in FIG. 7, may enable Host User Interface Servers 101 and Guest User Interface Servers 108 to take advantage of distributed computing and storage resources for distributing both indices and User Interface Displays across networks such as local area networks and the Internet.

However, although the automatic matching mechanism 100 is shown being used in a networked environment, it is contemplated that in other embodiments, the automatic matching mechanism 100 may operate in a stand-alone environment, such as on a single terminal.

### Specific Implementation Details

Various implementation details of the various functional blocks of the automatic matching mechanism 100 have been mentioned above. For example, in conjunction with the description of FIG. 1 through FIG. 7, various embodiments have referred to a categorizer and categorizer functionality that may be implemented in the GHCCOM 106 of FIG. 1. Accordingly, the following embodiments describe functionality that may be incorporated into various functional blocks of the automatic matching mechanism 100 described above.

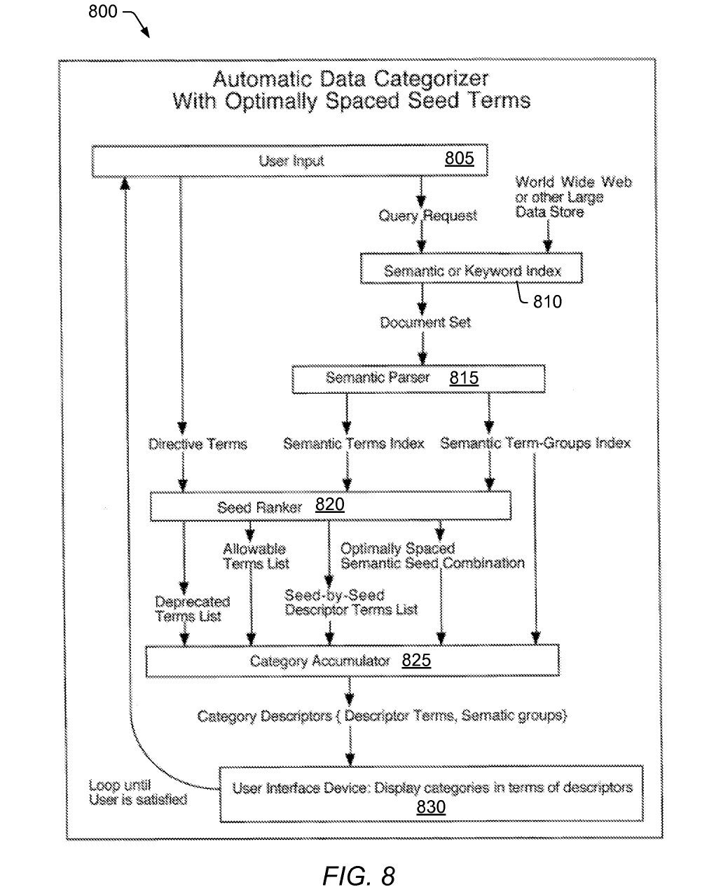

Referring to FIG. 8 a flow diagram depicting one embodiment of a method for automatically categorizing data is shown. In the illustrated embodiment, a Query Request originates from a person, such as a User of an application. For instance, a user of a search portal into the World Wide Web might submit a Search Term via a user input (block 805), which would be used as a Query Request. Alternatively, a user of a large medical database could name a Medical Procedure whose meaning would be used as a Query Request. Then the Query Request serves as input to a Semantic or Keyword Index (block 810) which in turn retrieves a Document Set corresponding to the Query Request.

If a Semantic Index is used, semantic meanings of the Query Request will select documents from the World Wide Web or other Large Data Store which have semantically related phrases. If a Keyword Index is used, the literal words of the Query Request will select documents from the World Wide Web or other Large Data Store which have the same literal words. Of course as described above, a Semantic Index, such as disclosed by U.S. patent application Ser. No. 10/329,402 is far more accurate than a Keyword Index.

In the illustrated embodiment, the output of the Semantic or Keyword Index is a Document Set, which may be a list of pointers to documents, such as URLs, or the documents themselves, or smaller specific portions of documents such as paragraphs, sentences or phrases, all tagged by pointers to documents. The Document Set is then input to a Semantic Parser (block 815), which segments data in the Document Set into meaningful semantic units, if the Semantic Index which produces the Document Set has not already done so. Meaningful semantic units include sentences, subject phrases, verb phrases and object phrases.

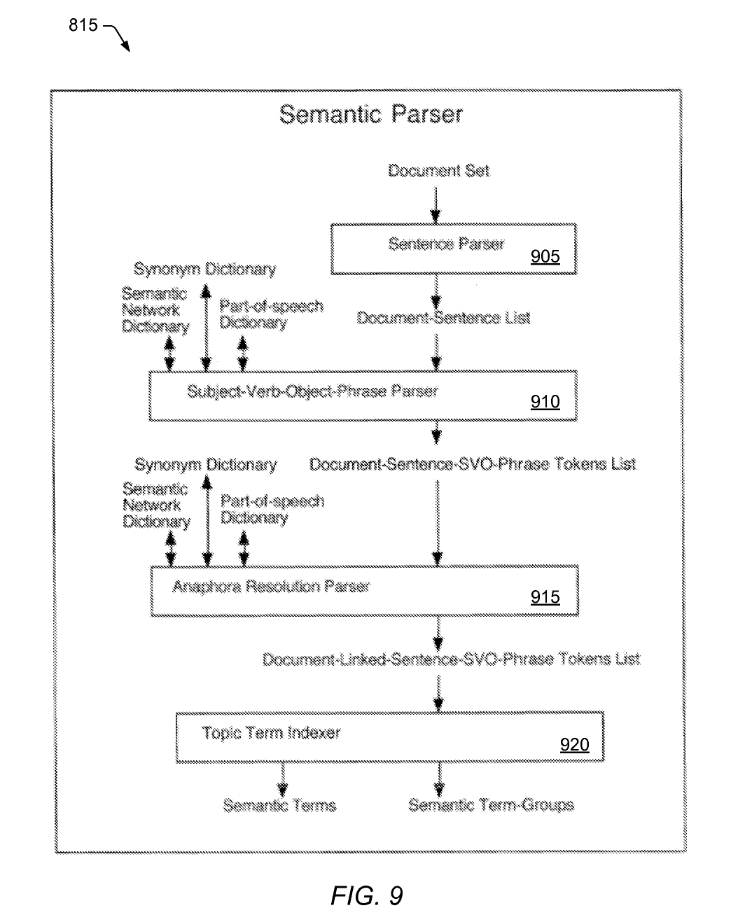

As shown in FIG. 9, a sentence parser 815 is shown. By first passing the Document Set through a Sentence Parser block 905, the Document Set can first be digested into individual sentences, by looking for end-of-sentence punctuations such as “?”,“.”,“!” and double line-feeds. The Sentence Parser 905 may output individual sentences tagged by pointers to documents, producing the Document-Sentence list.

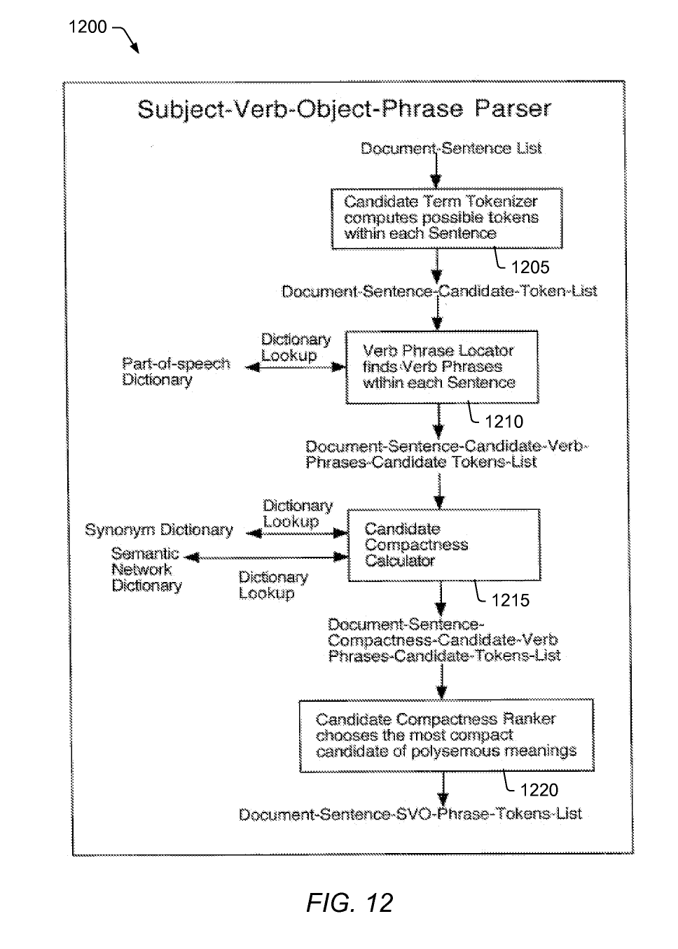

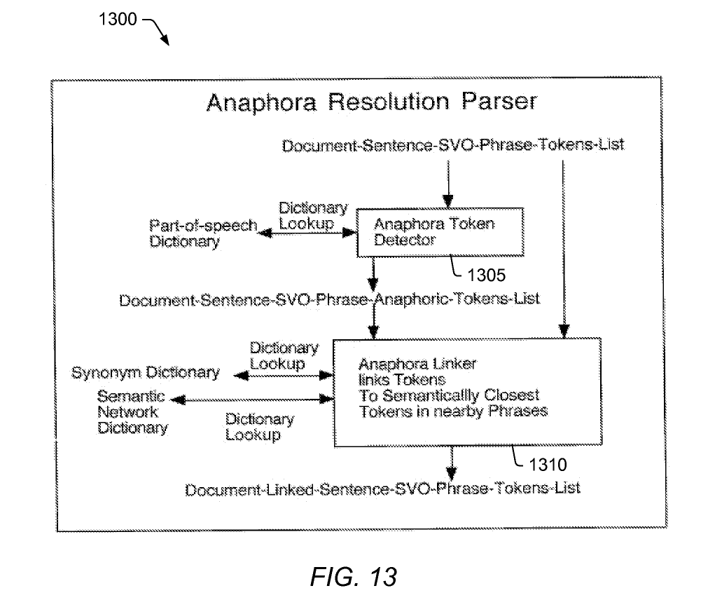

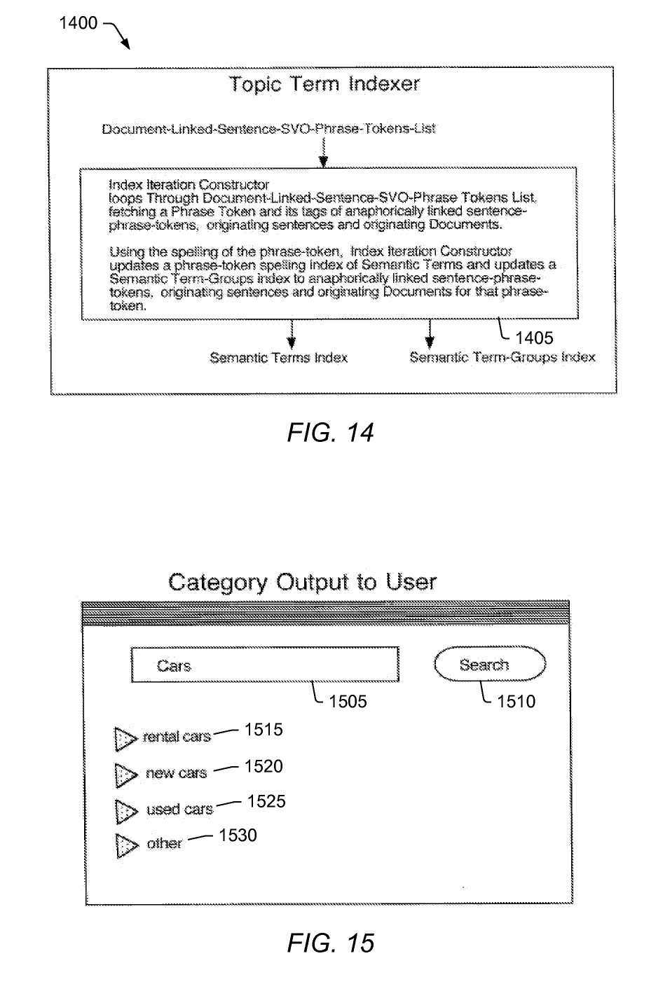

As shown in FIG. 12, a Semantic Network Dictionary, Synonym Dictionary and Part-of-Speech Dictionary can then be used to parse sentences into smaller semantic units. For each individual sentence, the Candidate Term Tokenizer computes possible tokens within each sentence (block 1205) by looking for possible one, two and three word tokens. For instance, the sentence “time flies like an arrow” could be converted to Candidate Tokens of “time”, “flies”, “like”, “an”, “arrow”, “time flies”, “flies like”, “like an”, “an arrow”, “time flies like”, “flies like an”, “like an arrow”. The Candidate Term Tokenizer produces a Document-Sentence-Candidate-Token-List containing Candidate Tokens tagged by their originating sentences and originating Documents. Sentence by sentence, the Verb Phrase Locator then looks up Candidate Tokens in the Part-of-speech dictionary to find possible Candidate Verb Phrases (block 1210). The Verb Phrase Locator produces a Document-Sentence-Candidate-Verb-Phrases-Candidate Tokens-List which contains Candidate Verb Phrases tagged by their originating sentences and originating Documents. This list is surveyed by the Candidate Compactness Calculator (block 1215), which looks up Candidate Tokens in a Synonym Dictionary and Semantic Network Dictionary to compute the compactness of each Candidate Verb Phrases competing for each sentence. The compactness of each Candidate may be a combination of semantic distance from a Verb Phrase Candidate to other phrases in the same sentence, or the co-location distance of tokens of the Verb Phrase to each other, or the co-location or semantic distance to proxy synonyms in the same sentence. The Candidate Compactness Calculator produces the Document-Sentence-Compactness-Candidate-Verb Phrases-Candidate-Tokens-List in which each Candidate Verb Phrase has been tagged by a Compactness number and tagged by their originating sentences and originating documents.

The Document-Sentence-Compactness-Candidate-Verb Phrases-Candidate-Tokens-List is then winnowed out by the Candidate Compactness Ranker which chooses the most semantically compact competing Candidate Verb Phrase for each sentence (block 1220). The Candidate Compactness Ranker then produces the Subject and Object phrases from nouns and adjectives preceding and following the Verb Phrase for each sentence, thus producing the Document-Sentence-SVO-Phrase-Tokens-List of Phrase Tokens tagged by their originating sentences and originating Documents.

Referring back to FIG. 9, the Document-Sentence-SVO-Phrase-Tokens-List is input to the Anaphora Resolution Parser 915. Since the primary meaning of one sentence often connects to a subsequent sentence through anaphora, it is very important to link anaphora before categorizing clusters of meaning. For instance “Abraham Lincoln was President during the Civil War. He wrote the Emancipation Proclamation” is implies “Abraham Lincoln wrote the Emancipation Proclamation.” Linking the anaphoric word “He” to “Abraham Lincoln” resolves that implication. In FIG. 6, the Anaphora Token Detector uses a Part-of-speech Dictionary to lookup anaphoric tokens such he, she, it, them, we, they. The Anaphora Token Detector produces the Document-Sentence-SVO-Phrase-Anaphoric-Tokens-List of Anaphoric Tokens tagged by originating Documents, sentences, subject, verb, or object phrases. The Anaphora Linker then links these unresolved anaphora to nearest subject, verb or object phrases. The linking of unresolved anaphora can be computed by a combination of semantic distance from an Anaphoric Token to other phrases in the same sentence, or the co-location distance of an Anaphoric Token to other phrases in the same sentence, or the co-location or semantic distance to phrases in preceding or following sentences.

The Anaphora Linker produces the Document-Linked-Sentence-SVO-Phrase-Tokens-List of Phrase Tokens tagged by their anaphorically linked sentence-phrase-tokens, originating sentences and originating Documents.

The Document-Linked-Sentence-SVO-Phrase-Tokens-List is input to the Topic Term Indexer 920. The Topic Term Indexer loops through each Phrase Token in the Document-Linked-Sentence-SVO-Phrase-Tokens-List, recording the spelling of the Phrase Token in Semantic Terms Index. The Topic Term Indexer also records the spelling of the Phrase Token as pointing to anaphorically linked sentence-phrase-tokens, originating sentences and originating Documents in the Semantic Term-Groups Index. The Semantic Term-Groups Index and Semantic Terms Index are both passed as output from the Topic Term Indexer. To conserve memory, the Semantic Term-Groups Index can serve in place of Semantic Terms Index, so that only one indexes if passed as output of the Topic Term Indexer.

Referring back to FIG. 8, the Semantic Terms Index, the Semantic Term-Groups Index and any Directive Terms from the user are passed as input to the Seed Ranker 820. Directive Terms include any terms from User Input or an automatic process calling the Automatic Data Categorizer which have special meaning to the Seed Ranking process. Special meanings include terms to be precluding from Seed Ranking or terms which must be included as Semantic Seeds the Seed Ranking process. For instance, a user may have indicated that “rental” be excluded from and “hybrid” be included in Semantic Seed Terms around which categories are to be formed.

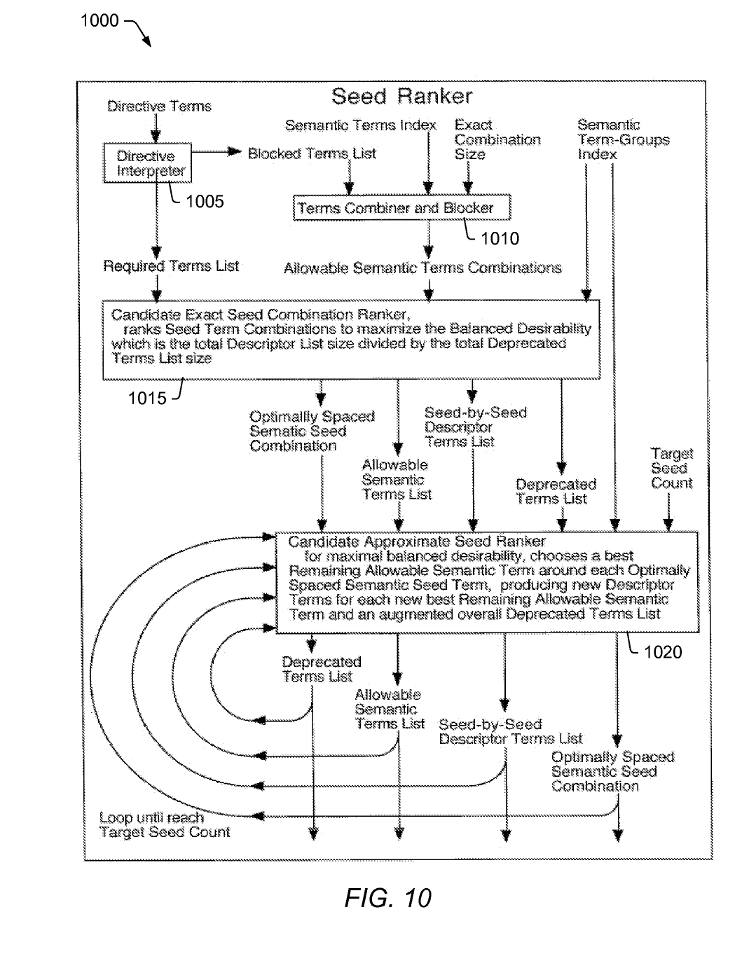

In FIG. 10, the Seed Ranker flow diagram shows how inputs of Directive Terms, Semantic Terms Index and Semantic Term-Groups Index are computed to produced Optimally Spaced Seed Terms. The Directive Interpreter takes input Directive Terms such as “Not rental but hybrid” and parses the markers of “Not” and “but” to produce a Blocked Terms List of “rental” and a Required Terms List of “hybrid”. This parsing can be done on a keyword basis, synonym basis or by semantic distance methods as in U.S. patent application Ser. No. 10/329,402. If done on a keyword basis the parsing will be very quick, but not as accurate as on a synonym basis. If done on a synonym basis, the parsing will be quicker but not as accurate than parsing done on a semantic distance basis.

The Blocked Terms List, Semantic Terms Index and Exact Combination Size are inputs to Terms Combiner and Blocker 1010. The Exact Combination Size controls the number of seed terms in a candidate combination. For instance, if a Semantic Terms Index contained N terms, the number of possible two-term combinations would be N times N minus one. The number of possible three-term combinations would be N times (N minus one) times (N minus two). Consequently a single processor implementation of the present invention would limit Exact Combination Size to a small number like 2 or 3. A parallel processing implementation or very fast uni-processor could compute all combinations for a higher Exact Combination Size.

The Terms Combiner and Blocker 1010 prevent any Blocked Terms in the Blocked Terms list from inclusion in Allowable Semantic Terms Combinations. The Terms Combiner and Blocker 1010 also prevents any Blocked Terms from participating with other terms in combinations of Allowable Semantic Terms Combinations. The Terms Combiner and Blocker 1010 produces the Allowable Semantic Terms Combinations as output.

Together the Allowable Semantic Terms Combinations, Required Terms List and Semantic Term-Groups Index are input to the Candidate Exact Seed Combination Ranker 1015. Here each Allowable Semantic Term Combination is analyzed to compute the Balanced Desirability of that Combination of terms. The Balanced Desirability takes into a account the overall prevalence of the Combination's terms, which is a desirable, against the overall closeness of the Combination's terms, which is undesirable.

The overall prevalence is usually computed by counting the number of distinct terms, called peer-terms, co-located with the Combination's terms within phrases of the Semantic Term-Groups Index. A slightly more accurate measure of overall prevalence would also include the number of other distinct terms co-located with the distinct peer-terms of the prevalence number. However this improvement tends to be computationally expensive, as are similar improvements of the same kind, such as semantically mapping synonyms and including them in the peer-terms. Other computationally fast measures of overall prevalence can be used, such as the overall number of times the Combination's terms occur within the Document Set, but these other measures tend to be less semantically accurate.

The overall closeness of the Combination's terms is usually computed by counting the number of distinct terms, called Deprecated Terms, which are terms co-located with two or more of the Combination's Seed Terms. These Deprecated Terms are indications that the Seed Terms actually collide in meaning. Deprecated Terms cannot be used to compute a Combination's Prevalence, and are excluded from the set of peer-terms in the above computation of overall prevalence for the Combination.

The Balanced Desirability of a Combination of terms is its overall prevalence divided by its overall closeness. If needed, this formula can be adjusted to favor either prevalence or closeness in some non-linear way. For instance, a Document Set like a database table may have an unusually small number of distinct terms in each sentence, so that small values prevalence need a boost to balance with closeness. In such cases, the formula might be overall prevalence times overall prevalence divided by overall closeness.

For an example of computing the Balanced Desirability of Seed Terms, Semantic Terms of gas/hybrid and “hybrid electric” are frequently co-located within sentences of documents produces by a keyword or semantic index on “hybrid car.” Therefore, an Exact Combination Size of 2 could produce an Allowable Semantic Term Combination of gas/hybrid and “hybrid electric” but the Candidate Exact Seed Combination Ranker would reject it in favor of an Allowable Semantic Term Combination of slightly less overall prevalence but much less collision between its component terms, such as “hybrid technologies” and “mainstream hybrid cars”. The co-located terms shared between seed Semantic Terms are output as Deprecated Terms List. The co-located terms which are not Deprecated Terms but are co-located with individual seed Semantic Terms are output as Seed-by-Seed Descriptor Terms List. The seed Semantic Terms in the best-ranked Allowable Semantic Term Combination are output as Optimally Spaced Semantic Seed Combination. All other Semantic Terms from input Allowable Semantic Terms Combinations are output as Allowable Semantic Terms List.

In variations of the present invention where enough compute resources are available to compute with Exact Combination Size equal to the desired number of Optimally Spaced Seed Terms, the above outputs are final output from the Seed Ranker, skipping all computation in the Candidate Approximate Seed Ranker 1020 in FIG. 10 and just passing the Deprecated Terms List, Allowable Semantic Terms List, Seed-by-Seed Descriptor Terms List and Optimally Spaced Semantic Seed Combination as output directly from Candidate Exact Seed Combination Ranker 1015.

However most implementations of the present invention do not have enough compute resources to compute the Candidate Exact Seed Combination Ranker 1020 with Exact Combination Size greater than two or three. Consequently, a Candidate Approximate Seed Ranker 1020 is needed to produced a larger Seed Combination of four or five or more Seed Terms. Taking advantage of the tendency of optimal set of two or three Seed Terms to define good anchor points for seeking additional Seeds, to acquire a few more nearly optimal seeds, as shown in FIG. 10, a Candidate Approximate Seed Ranker 1020 takes input of Optimally Spaced Semantic Seed Combination, Allowable Semantic Terms, Seed-by-Seed Descriptor Terms and Deprecated Terms.

The Candidate Approximate Seed Ranker 1020 checks the Allowable Semantic Terms List term by term, seeking the candidate term whose addition to the Optimally Spaced Semantic Seed Combination would have the greatest Balanced Desirability in terms of a new overall prevalence which includes additional peer-terms corresponding to new distinct terms co-located the candidate term, and a new overall closeness, which includes co-location term collisions between the existing Optimally Spaced Semantic Seed Combination and the candidate term. After choosing a best new candidate term and adding it to the Optimally Spaced Semantic Seed Combination, the Candidate Approximate Seed Ranker 1020 stores a new augmented Seed-by-Seed Descriptor Terms List with the peer-terms of the best candidate term, a new augmented Deprecated Terms List with the term collisions between the existing Optimally Spaced Semantic Seed Combination and the best candidate term, and a new smaller Allowable Semantic Terms List missing any terms of the new Deprecated Terms List or Seed-by-Seed Descriptor Terms Lists.

The system loops through the Candidate Approximate Seed Ranker 1020 accumulating Seed Terms until the Target Seed Count is reached. When the Target Seed Count is reached, the then current Deprecated Terms List, Allowable Semantic Terms List, Seed-by-Seed Descriptor Terms List and Optimally Spaced Semantic Seed Combination become final output of the Seed Ranker of FIG. 10.

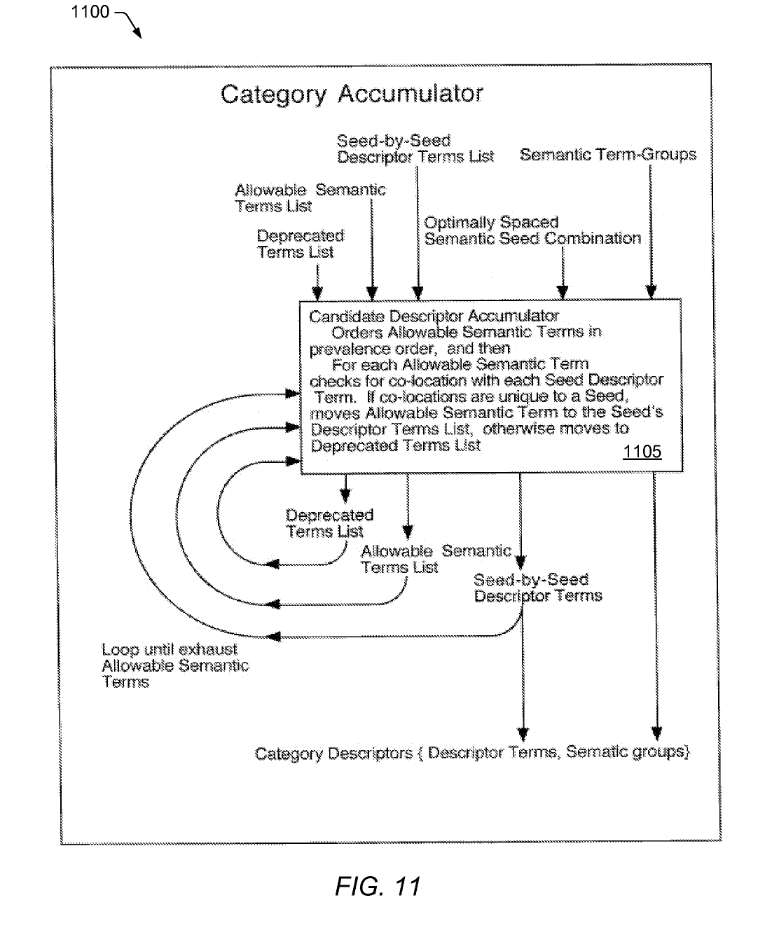

FIG. 8 shows that outputs of the FIG. 10 Seed Ranker 1000, together with the Semantic Term-Groups Index, are passed as input to the Category Accumulator 825. FIG. 11 shows a detail flow diagram of computation typical of a Category Accumulator 1100 such as the Category Accumulator 825 of FIG. 8. The purpose of the Category Accumulator 1100 is to deepen the list of Descriptor Terms which exists for each Seed of the Optimally Spaced Semantic Seed Combination. Although Seed-by-Seed Descriptor Terms are output in lists for each Seed of the Optimally Spaced Semantic Seed Combination by the Seed Ranker of FIG. 10, the Allowable Semantic Terms List generally contains semantic terms which are pertinent to specific Seeds.

To add these pertinent semantic terms to the Seed-by-Seed Descriptor Terms List of the appropriate Seed, the Category Accumulator 1100 orders Allowable Semantic Terms in term prevalence order, where term prevalence is usually computed by counting the number of distinct terms, called peer-terms, co-located with the Allowable Term within phrases of the Semantic Term-Groups Index. A slightly more accurate measure of term prevalence would also include the number of other distinct terms co-located with the distinct peer-terms of the prevalence number. However this improvement tends to be computationally expensive, as are similar improvements of the same kind, such as semantically mapping synonyms and including them in the peer-terms. Other computationally fast measures of term's prevalence can be used, such as the overall number of times the Allowable Term occurs within the Document Set, but these other measures tend to be less semantically accurate.

The Category Accumulator 1100 then traverses the ordered list of Allowable Semantic Terms, to work with one candidate Allowable Term at a time. If the candidate Allowable Term co-locates within phrases of the Semantic Term-Groups with Seed Descriptor Terms of only one Seed, then the candidate Allowable Term is moved to that Seed's Seed-by-Seed Descriptor Terms List. However if the candidate Allowable Term co-locates within phrases of the Semantic Term-Groups with a Seed-by-Seed Descriptor Terms List of more than one Seed, the candidate Allowable Term is moved to the Deprecated Terms List. If the candidate Allowable Term co-locates within phrases of the Semantic Term-Groups with Seed Descriptor Terms of no Seed, the candidate Allowable Term is an orphan term and is simply deleted from the Allowable Terms List.

The Category Accumulator 1100 continues to loop through the ordered Allowable Semantic Terms, deleting them or moving them to either the Deprecated Terms List or one of the Seed-by-Seed Descriptor Terms Lists until all Allowable Semantic Terms are exhausted and the Allowable Semantic Terms List is empty. Any Semantic Term-Groups which did not contribute Seed-by-Seed Descriptor Terms can be categorized as belonging to a separate “other . . . ” category with its own Other Descriptor Terms consisting of Allowable Semantic Terms which were deleted from the Allowable Semantic Terms List.

As a final output, the Category Accumulator 100 packages each Seed Term of the Optimally Spaced Semantic Seed Combination with a corresponding Seed-by-Seed Descriptor Terms List and with a corresponding list of usage locations from the Document Set's Semantic Term-Groups Index such as documents, sentences, subject, verb or object phrases. This output package is collectively called the Category Descriptors which are the output of the Category Accumulator 1100.

Some variations of the present inventions will keep the Seed-by-Seed Descriptor Terms List in the accumulated order. Others will sort the Seed-by-Seed Descriptor Terms List by prevalence order, as defined above, or by semantic distance to Directive Terms or even alphabetically, as desired by users of an application calling the Automatic Categorizer for user interface needs.

In FIG. 8 the Category Descriptors are input to the User Interface Device 830. The User Interface Device 830 displays or verbally conveys the Category Descriptors as meaningful categories to a person using an applications such as a web search application, chat web search application or cell phone chat web search application. FIG. 15 shows an example of a web search application with a box for User Input at top left, a Search button to initiate processing of User Input at top right, and results from processing User Input below them. The box for User Input shows “Cars” as User Input. The Search Results from “Cars” is shown as three categories displayed as their seed terms of “rental cars,” “new cars,” “user cars.” Documents and their Semantic Term-Groups which did not contribute to these three seed term Seed-by-Seed Descriptor Terms Lists are summarized under the “other . . . ” category.

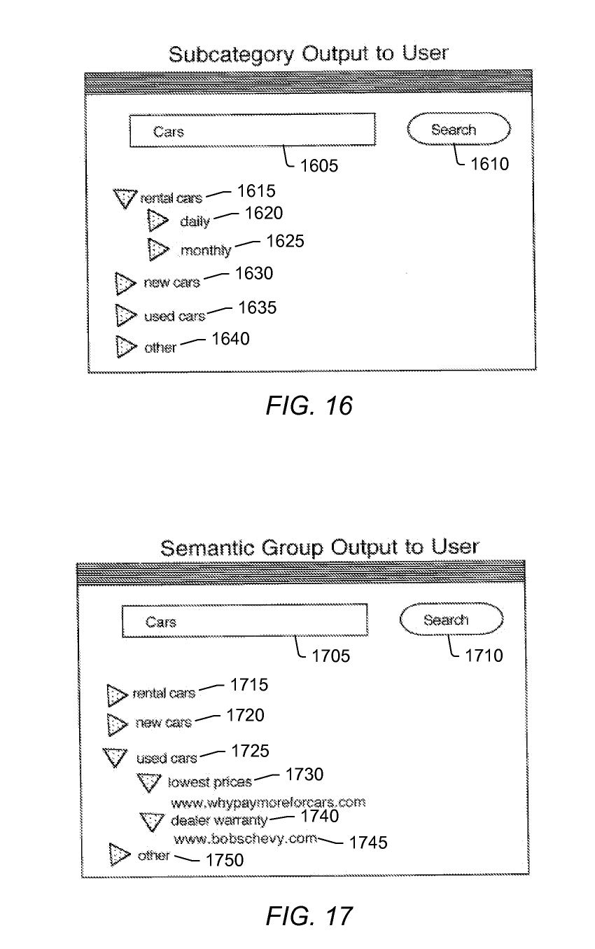

FIG. 16 shows the User Interface Device of FIG. 15 with the triangle icon of “rental cars” clicked open to reveal subcategories of “daily” and “monthly.” Similar displayed subcategories may be selected either from highly prevalent terms in the category's Seed-by-Seed Descriptor Terms List, or by entirely rerunning the Automatic Data Categorizer upon a subset of the Document Set pointed to by the Category Descriptors for the “rental cars” category.

FIG. 17 shows the User Interface Device of FIG. 15 with the triangle icon of “used cars” clicked open to show individual web site URLs and best URL Descriptors for those web site URLs. When a category such as “used cars” has only a few web sites pointed to by the Category Descriptors for the “used cars” category, users will generally want to see them all at once, or in the case of a telephone User Interface Device, users will want to hear about them all at once, as read aloud by a voiced synthesizer. Best URL Descriptors can be chosen from the most prevalent terms pointed to by the Category Descriptors for the “used cars” category. In cases where two or more prevalent terms are nearly tied for most prevalent, they can be concatenated together, to display or read aloud by a voice synthesizer as a compound term such as “dealer warranty.”

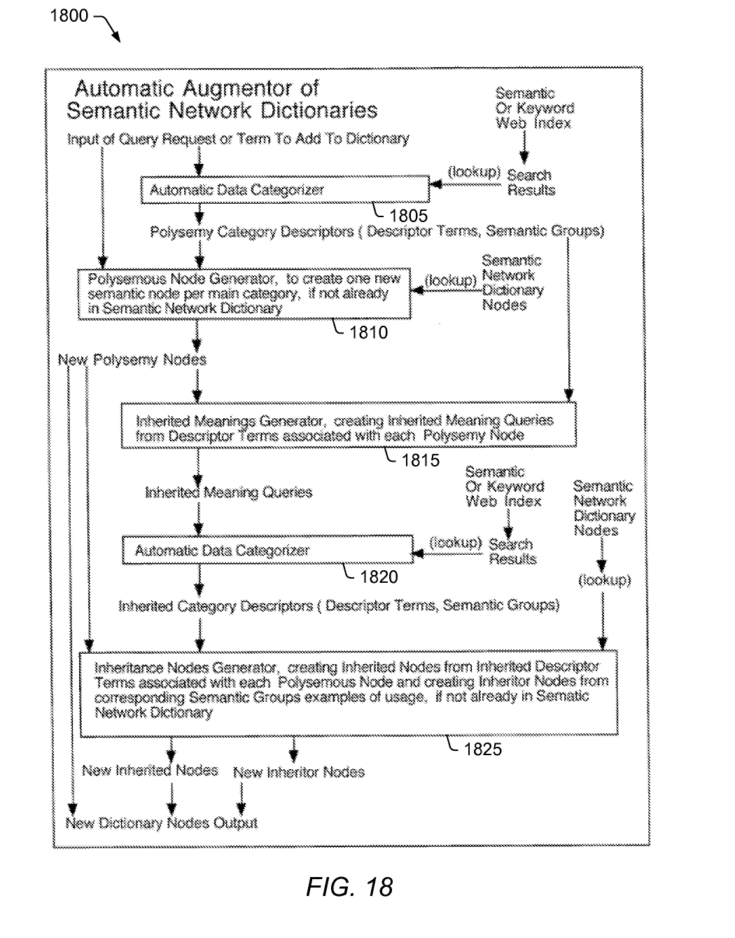

FIG. 18 shows a high level flow diagram of a method to automatically augment a semantic network dictionary. One of the significant drawbacks of traditional semantic network dictionaries is the typically insufficient semantic coverage enabled by hand-built dictionaries. U.S. patent application Ser. No. 10/329,402 discloses automatic methods to augment semantic network conversations through conversations with application users. However, the quality of those applications depends greatly upon the pre-existing semantic coverage of the semantic network dictionary.

Rather than subject users to grueling bootstrapping phase during which the user must tediously converse about building block fundamental semantic terms, essentially defining a glossary through conversation, an end-user application can acquire vocabulary just-in-time to converse about it intelligently. By taking a user's conversational input, and treating it as a query request to a Semantic or Keyword Index, the Document Set which results from that query run through the Automatic Data Categorizer of FIG. 8. The Category Descriptors from that run can be used to direct the automatic construction of semantically accurate vocabulary related to the user's conversational input, all before responding to the user conversationally. Thus the response to the user utilizes vocabulary which did not exist in the semantic network dictionary before the user's conversational input was received. Thus vocabulary generated just-in-time for an intelligent response can take the place of tedious conversation about building block fundamental semantic terms. For instance, if the user's conversational input mentioned hybrid cars, and the semantic network dictionary did not have vocabulary for the terms gas-electric or “hybrid electric”, these terms could be quickly automatically added to the semantic network dictionary before continuing to converse with the user about “hybrid cars”.

FIG. 18 takes an input of a Query Request or a Term to add to a dictionary such as “hybrid cars” and sends through the method of FIG. 8, which returns corresponding Category Descriptors. Each seed term of the Category descriptors can be used to define a polysemous meaning for “hybrid cars.” For instance, even if the seed terms are not exactly what a lexicographer would define as meanings, such as “Toyota Hybrid,” “Honda Hybrid” and “Fuel Cell Hybrid” each seed term can generate a semantic network node of the same spelling, to be inherited by individual separate polysemous nodes of “hybrid cars.” The Polysemous Node Generator of FIG. 18 creates these nodes. Then, the meaning of each individual separate polysemous nodes of “hybrid cars” can be further defined, as a lexicographer would appreciate, by re-querying the Semantic or Keyword Index with each Descriptor Term that was just linked as an inherited term of an individual separate polysemous nodes of “hybrid cars”. So for instance “Toyota Hybrid” would be used as input to the method of FIG. 8, to produced Category Descriptor Seed Terms describing “Toyota Hybrid,” such as “Hybrid System,” “Hybrid Lexus” and “Toyota Prius”. The Inheritance Nodes Generator of FIG. 18 created nodes of these spellings, if not already in the Semantic Network Dictionary, and links them to make them inherited by the corresponding individual separate polysemous node such as “hybrid cars” created to describe “Toyota Hybrid.”

One advantage of automatically generating semantic network vocabulary is low labor costs and up-to-date meanings for nodes. Although a very large number of nodes may be created, even after checking to make sure that no node of the same spelling or same spelling related through morphology already exists (such as cars related to car), methods disclosed by U.S. patent application Ser. No. 10/329,402 may be used to later simplify the semantic network by substituting one node for another node when both nodes having essentially the same semantic meaning.

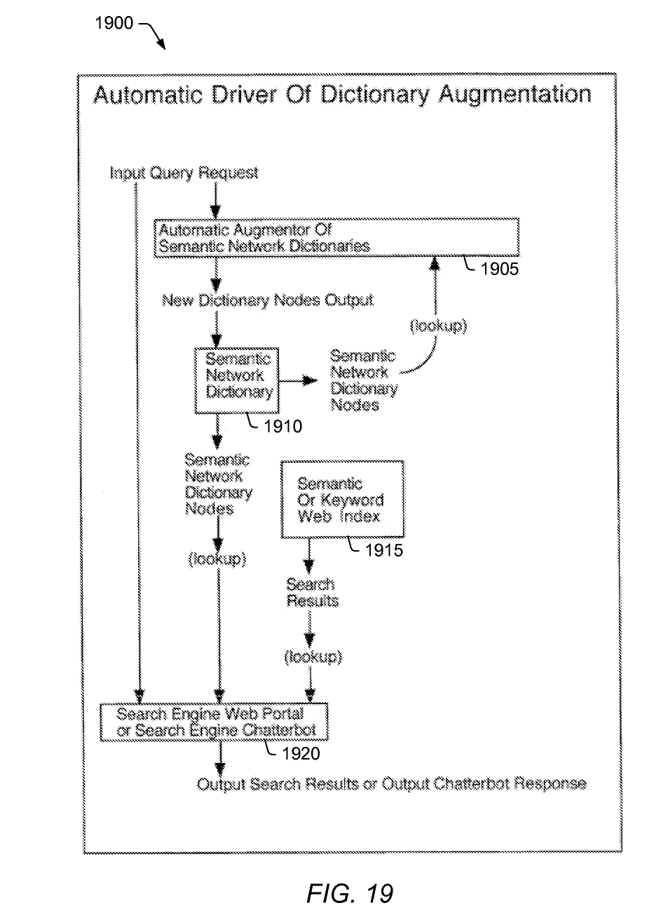

FIG. 19 shows the method of FIG. 18 deployed in a conversational user interface. Input Query Request, which comes from an application user, is used as input to the method of FIG. 18 to automatically augment a semantic network dictionary. Semantic network nodes generated by the method of FIG. 18 join a Semantic Network Dictionary which is the basis of conversational or semantic search methods used by a Search Engine Web Portal or Search Engine Chatterbot. The Search Engine Web Portal or Search Engine Chatterbot looks up User Requests in the Semantic Network Dictionary to better understand from a semantic perspective what the User is actually Requesting. In this way, the Web Portal can avoid retrieving extraneous data corresponding to keywords which accidentally are spelled within the search request. For instance, a User Request of “token praise” passed to a keyword engine can return desired sentences such as “This memorial will last long past the time that token praise will be long forgotten.” However a keyword engine or semantic engine missing vocabulary related the meaning of “token praise” will return extraneous sentences such as the child behavioral advice “Pair verbal praise with the presentation of a token” and the token merchant customer review of “Praise: tokens and coins shipped promptly and sold exactly as advertised . . . four star rating”. By just-in-time vocabulary augmentation as disclosed in FIG. 19, the meaning of “token praise” and other sophisticated semantic terms can be added to a semantic dictionary just-in-time to remove extraneous data from search result sets using methods disclosed by U.S. patent application Ser. No. 10/329,402. In addition, just-in-time vocabulary augmentation as disclosed in FIG. 19 can enable subsequent automatic categorization to be more accurate, by more accurately associating semantic synonyms and semantically relating spellings so that co-locations of meaning can be accurately detected when calculating prevalence of meanings. More accurate association of semantic synonyms and semantically relating spellings also enables more accurate detection of Seed-by-Seed Descriptor Terms and Deprecated Terms in FIG. 10, by detecting Descriptor Terms and Deprecated Terms not only on the basis of co-located spellings, but co-located synonyms and co-located closely related meanings.

It is noted that embodiments described above may be implemented using hardware, software, or a combination thereof and may be implemented in one or more computer systems or other processing systems as described above.

Although the embodiments above have been described in considerable detail, numerous variations and modifications will become apparent to those skilled in the art once the above disclosure is fully appreciated. It is intended that the following claims be interpreted to embrace all such variations and modifications.

1-20. (canceled)

21. A method comprising:
maintaining a semantic network dictionary hierarchy that includes nodes indicative of semantic relationships between content in a first data store that includes guest content for supplementing host content stored on a host computer system, wherein the semantic network dictionary hierarchy includes information indicative of semantic distances between the nodes;
receiving a query request directed to the host computer system, wherein the query request comprises one or more terms;
using the one or more terms in the query request to augment the semantic network dictionary hierarchy by automatically recomputing the semantic distances between the nodes;
querying the augmented semantic network dictionary hierarchy using the one or more terms in the query request; and
selecting guest content responsive to said querying, wherein the selected guest content is usable to supplement the host content provided by the host computer system.

22. The method as recited in claim 21, wherein the query request comprises user input.

23. The method as recited in claim 21, wherein the query request comprises conversational input from a user.

24. The method as recited in claim 21, wherein said using the one or more terms in the query request to augment the semantic network dictionary hierarchy comprises adding one or more new nodes to the semantic network dictionary hierarchy based on the one or more terms in the query request.

25. The method as recited in claim 21, wherein the selected guest content comprises categorized web content.

26. The method as recited in claim 21, wherein the selected guest content comprises one or more advertisements.

27. The method as recited in claim 21, wherein the selected guest content and the host content are provided to a client computer system for display using a web browser.

28. A system comprising:
a processor configured to execute instructions; and
a memory coupled to the processor, wherein the memory stores program instructions executable by the processor to:
receive a query request;
augment a semantic network dictionary hierarchy using the query request, wherein the semantic network dictionary hierarchy includes nodes indicative of semantic relationships between content in a first data store that includes guest content for supplementing host content, wherein the semantic network dictionary hierarchy includes information indicative of semantic distances between the nodes, wherein augmenting the semantic network dictionary hierarchy comprises recomputing the semantic distances between the nodes; and
use the augmented semantic network dictionary hierarchy to select guest content responsive to the query request.

29. The system as recited in claim 28, wherein the query request comprises user input.

30. The system as recited in claim 28, wherein the query request comprises conversational input from a user.

31. The system as recited in claim 28, wherein said using the one or more terms in the query request to augment the semantic network dictionary hierarchy comprises adding one or more new nodes to the semantic network dictionary hierarchy based on the one or more terms in the query request.

32. The system as recited in claim 28, wherein the selected guest content comprises categorized web content.

33. The system as recited in claim 28, wherein the selected guest content comprises one or more advertisements.

34. The system as recited in claim 28, wherein the selected guest content and the host content are provided to a client computer system for display using a web browser.

35. A computer usable storage medium comprising program instructions, wherein the program instructions are executable to implement:
receiving a content request comprising one or more terms;
using the one or more terms in the content request to augment a semantic network dictionary hierarchy, wherein the semantic network dictionary hierarchy includes nodes indicative of semantic relationships between elements of guest content in a first data store, wherein the semantic network dictionary hierarchy includes information indicative of semantic distances between the nodes, wherein augmenting the semantic network dictionary hierarchy comprises recomputing the semantic distances between the nodes; and
selecting guest content responsive to the content request using the augmented semantic network dictionary hierarchy, wherein the selected guest content supplements host content provided by a host computer system.

36. The computer usable storage medium as recited in claim 35, wherein the query request comprises user input.

37. The computer usable storage medium as recited in claim 35, wherein the query request comprises conversational input from a user.

38. The computer usable storage medium as recited in claim 35, wherein said using the one or more terms in the query request to augment the semantic network dictionary hierarchy comprises adding one or more new nodes to the semantic network dictionary hierarchy based on the one or more terms in the query request.

39. The computer usable storage medium as recited in claim 35, wherein the selected guest content comprises categorized web content.

40. The computer usable storage medium as recited in claim 35, wherein the selected guest content comprises one or more advertisements.

41. A method comprising:
sending a content request to a host computer system, wherein a semantic network dictionary hierarchy is augmented using the content request, wherein the semantic network dictionary hierarchy includes nodes indicative of semantic relationships between content in a first data store that includes guest content, wherein the semantic network dictionary hierarchy includes information indicative of semantic distances between the nodes, wherein augmenting the semantic network dictionary hierarchy comprises recomputing the semantic distances between the nodes, wherein the augmented semantic network dictionary hierarchy is used to select guest content responsive to the content request;
receiving the selected guest content; and
providing a web page for display, wherein the web page comprises the selected guest content.

42. A system comprising:
a processor configured to execute instructions; and
a memory coupled to the processor, wherein the memory stores program instructions executable by the processor to:
generate a request for guest content, wherein a semantic network dictionary hierarchy is augmented using the request for guest content, wherein the semantic network dictionary hierarchy includes nodes indicative of semantic relationships between content in a first data store that includes the guest content, wherein the semantic network dictionary hierarchy includes information indicative of semantic distances between the nodes, wherein augmenting the semantic network dictionary hierarchy comprises recomputing the semantic distances between the nodes, wherein the augmented semantic network dictionary hierarchy is used to select guest content responsive to the request for guest content;
generate a web page comprising host content and the selected guest content; and
send the web page to a client computer system.
